(19) United States
(12) Patent Application Publication
(10) Pub. No.: US 2017/0039876 A1
(43) Pub. Date: Feb. 9, 2017

(54) SYSTEM AND METHOD FOR IDENTIFYING LEARNER ENGAGEMENT STATES

(71) Applicant: Intel Corporation, Santa Clara, CA (US)

(72) Inventors: NESE ALYUZ CIVITCI, Istanbul (TR); EDA OKUR, Istanbul (TR); ASLI ARSLAN ESME, Istanbul (TR); SINEM ASLAN, Istanbul (TR); ECE OKTAY, Istanbul (TR); SINEM E. METE, Istanbul (TR); DAVID STANHILL, Hoshaya (IL); VLADIMIR SHLAIN, Haifa (IL); PINI ABRAMOVITCH, Haifa (IL); EYAL ROND, Sunnyvale, CA (US); ALEX KUNIN, Haifa (IL); ILAN PAPINI, Haifa (IL)

(21) Appl. No.: 14/820,297

(22) Filed: Aug. 6, 2015

(51) Int. Cl. G09B 19/00; G09B 5/00; G09B 7/00

(52) U.S. Cl. CPC G09B 19/00; G09B 7/00; G09B 5/00

(57) ABSTRACT

Embodiments herein relate to identifying a learning engagement state of a learner. A computing platform with one or more processors running modules may receive indications of interactions of a learner with an educational program as well as indications of physical responses of the learner collected substantially simultaneously as the learner interacts with the educational program. A current learning engagement state of the learner may be identified based at least in part on the received indications by using an artificial neural network associated that is calibrated to the learner. The artificial neural network may be trained and updated in part by human observation and learner self-reporting of the learner's current learning engagement state.

### FIELD

Embodiments of the present disclosure generally relate to the field of computer-based learning and in particular to identifying the engagement state of a learner during the learning process.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

With the rapid growth of computer-based training and computer-based education, adaptive learning technologies that enable identification of a learner's engagement state through real-time analysis of the learner's interaction with an educational device has improved a learner's ability to learn by altering the presented content based on the answers that the learner has gotten right or wrong. As an ever increasing number of learners may take advantage of this technology, accounting for individual student differences, for example learner behavior that is culturally-bounded or unique to the learner may be relevant to the effectiveness of computer-based education for that student.

### BRIEF DESCRIPTION OF THE DRAWINGS

Embodiments of the learner engagement state identification techniques of the present disclosure may overcome this limitation. The techniques will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a diagram of a computer-based learning environment incorporated with the learner engagement state identification techniques of the present disclosure, according to various embodiments.

FIG. 2 is a flow diagram illustrating a method for the operation of a learning engagement state recognition engine, according to various embodiments.

FIG. 3 is a flow diagram illustrating a method for training and/or calibrating an artificial neural network that may be associated with a learning engagement state recognition engine, according to various embodiments.

FIG. 4 is a flow diagram illustrating a method for operating the artificial neural network, according to various embodiments.

FIG. 5 is a flow diagram illustrating a method for labeling learning engagement states, according to various embodiments.

FIG. 6 illustrates a diagram illustrating an example user interface for a program used by human labelers to label learning engagement states, according to various embodiments.

FIG. 7 illustrates a component view of an example computer system suitable for practicing the disclosure, according to various embodiments

FIG. 8 illustrates an example storage medium with instructions configured to enable a computing device to practice the present disclosure, according to various embodiments.

### DETAILED DESCRIPTION

Apparatuses, methods and storage media associated with identifying a learning engagement state of a learner are described herein. In embodiments, an apparatus may include a computing platform with one or more processors running modules that receive indications of interactions of a learner with an educational program as well as indications of physical responses of the learner collected substantially simultaneously as the learner interacts with the educational program, and from that to identify a current learning engagement state of the learner based at least in part on the received indications by using an artificial neural network associated with the learner. The artificial neural network may be trained and updated in part by human observation and learner self-reporting of the learner's current learning engagement state, for example on-task or off-task.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternative embodiments of the present disclosure and their equivalents may be devised without parting from the spirit or scope of the present disclosure. It should be noted that like elements disclosed below are indicated by like reference numbers in the drawings.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or elements are in direct contact.

The term “real-time” may mean reacting to event at the same rate, or sometimes at the same rate as they unfold.

The term “substantially simultaneously” may mean at the same time or nearly at the same time.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

As used herein, the term “module” may refer to, be part of, or include an ASIC, an electronic circuit, a processor (shared, dedicated, or group) and/or memory (shared, dedicated, or group) that execute one or more software or firmware programs, a combinational logic circuit, and/or other suitable components that provide the described functionality.

This disclosure identifies an artificial intelligence (AI) based way of determining the level of learning engagement of a learner who is interacting with an educational program. In embodiments, an artificial neural network implements the AI concept of adaptive learning model associated with a particular learner. That way, in a semi-supervised approach, evaluations of the learner, over time, may result in highly accurate associations of a learner engagement state, which may include behavioral and/or emotional attributes, to observable characteristics of the learner using sensing data, environmental data, learner data, and data from an instruction module driving the educational device. These associations are then captured in an artificial neural network for the particular learner.

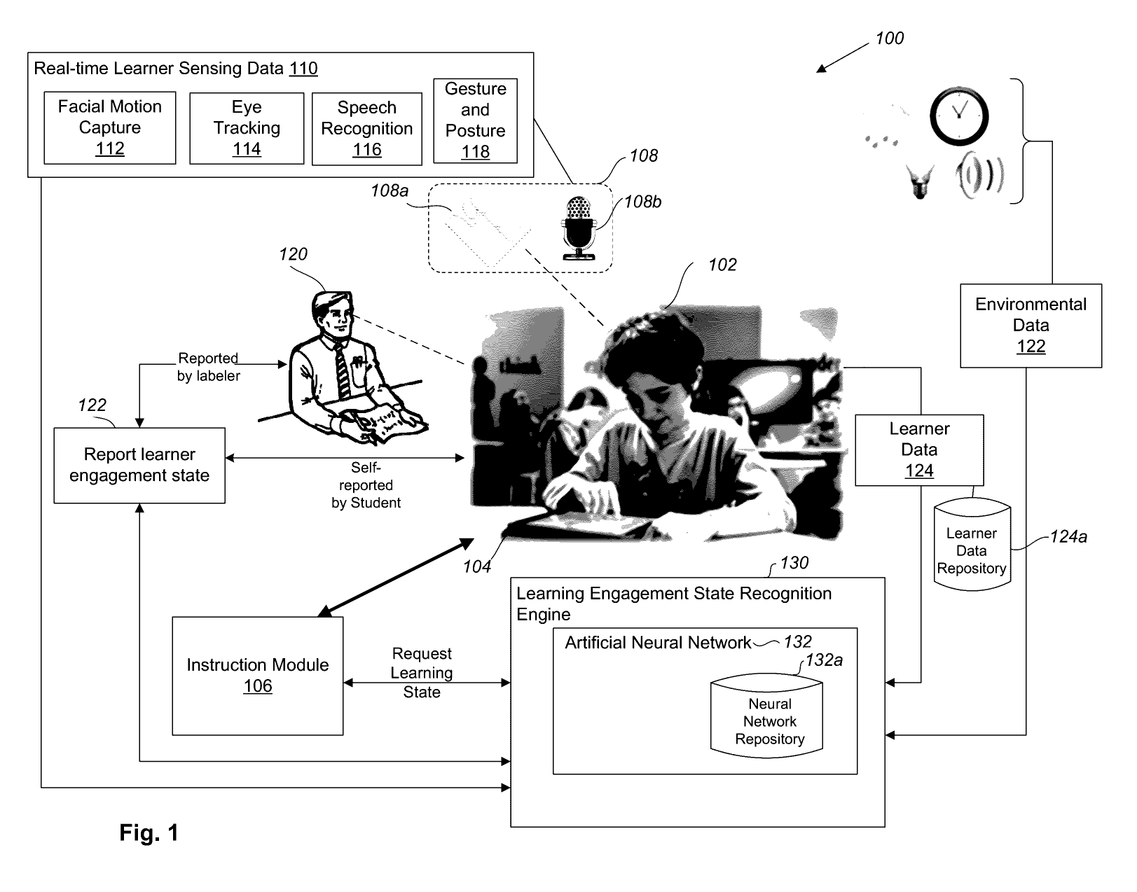

Referring now to FIG. 1, wherein a diagram of a computer-based learning environment incorporated with the learner engagement state identification techniques, according to various embodiments, may be shown. Diagram 100 may show a learning environment that may include a learner 102 interacting with an educational device 104 that may be driven by an instruction module 106. In embodiments, this learning environment 100 may be used for computer-based training to learn a specific task, for example how to play a game, or for user-paced education to learn broader concepts, such as history or philosophy.

As the learner 102 may interact with the educational device 104, the instruction module 106 may receive the current learning engagement state of the learner 102, and tailor the instructions based at least in part on the received current learning engagement state. In embodiments, the current learning engagement state may indicate the level of attention or inattention that the learner 102 has with regard to the learning device 104. In non-limiting examples, this may include learner 102 behavior such as on-task or off-task, or may include the learner 102 emotional state such as highly motivated, calm, bored, or confused/frustrated.

To determine and provide the current, or real-time engagement level of the learner 102, learner sensing equipment 108, such as a two-dimensional (2D) or three-dimensional (3D) video camera 108a, a microphone 108b or any other wide variety of equipment such as physiological sensors, accelerometers, or other soft sensors may be used to capture real-time learner sensing data 110 that the learning engagement state recognition engine 130 may use to determine the current learning engagement state of the learner 102. For example, the real-time learner sensing data 110 may include information regarding facial motion capture 112 that may capture facial expressions, head movement, and the like. Information regarding eye tracking 114 may capture the areas at which the learner 102 looks on the education device 104, or what the learner 102 is looking at if not looking at the device at all. Information regarding speech recognition 116 may capture phrases, questions, sounds of happiness or frustration of the learner 102. Information regarding gesture and posture 118 may capture a calm, focused state; a sleeping state; or an agitated and distracted state of the learner 102.

In embodiments, some or all of the learner sensing equipment 108 may be included as a part of the educational device 104 and/or the host apparatus of instruction module 106.

In addition to using sensing equipment 108, a report learner engagement state module 122 may ask for a real time learning state of learner 102 from a labeler 120 based on current observations, or from the learner 102 based on the learner's current experience.

In embodiments, a labeler 120, who may be in the form of a human observer, may be used to observe the learner 102, label the observed learning engagement state of the learner in real-time, and report the learning state. In embodiments, the labeler 120 may report learning engagement states for a particular learner 102, or may be observing a plurality of learners and report on any particular one of the plurality. The request may come from the instruction module 106, or from another source. In addition, in embodiments, the labeler 120 may be directly viewing the learner 102, or may be viewing the learner from a remote location using video camera 108a or microphone 108b that may be at the location of the learner 102. In embodiments, the labeler 120 may be looking at a pre-recorded session of the learner 102 and labeling learner engagement states in order to update/calibrate the artificial neural network 132 associated with the learner 102. While for ease of understanding, embodiments have been described with an artificial neural network (ANN), in alternative embodiments, element 130 may be practiced with any one of a number of artificial intelligence machine learning tools/techniques.

In embodiments, the learner 102 may be asked, for example by the instruction module 106 through the educational device 104, to indicate the learner's own assessment of the learner's current learning engagement state, based on the learner's current experience. In embodiments, the learner 102 may indicate a current learning state through an input selection on educational device 104, for example by selecting a choice in a pop-up window on a user interface screen (not shown), or by some other means such as speaking the learning engagement state that is recorded by microphone 108b. In embodiments, human labeling of engagement states may be requested either of the labeler 120, for example a teacher, or the learner 102. In embodiments, these current learning engagement state labels may include one or more behavioral states, for example body language indicating whether the learner is on or off task, and/or one or more emotional states, for example whether the learner appears excited, motivated or bored. In addition, cognitive elements may be included, for example, from results of the learner 102 interaction with the educational device 104.

In embodiments, the reliability of learning state labels may be far higher if expert and/or trained labelers are used, such as teachers who know the learner, or the learners themselves are asked to label their own learning engagement state. In these and other embodiments, the resulting labels may be considered highly reliable and may be used to train and/or to calibrate the artificial neural network (ANN) 132.

In addition to real-time learner sensing data, and reported learning state data by a labeler 120 or the learner 102, other relevant information may also be used by the learning engagement state recognition engine 130. For example, environmental data 122 may also be used. This data may include, but is not limited to, interior lighting, interior ambient noise, the current time, the month and day, and the outside weather, for example outside temperature, cloudiness, humidity, and the like.

In addition, learner data 124 may be used for a learner engagement state recognition engine 130. This data may include academic, medical, and/or psychological information about a learner 102, in addition to an identification of a learner. In embodiments, learner data 124 may include performance data captured by the learning environment. In embodiments, learner data 124 may be stored in a learner data repository 124a, which may include information for one or more learners.

Finally, the instruction module 106, that is driving the educational device 104, may provide information to the learning engagement state recognition engine 130. This information may include, but is not limited to, the correctness of answers to questions presented on educational device 104, learner interaction characteristics with the educational device 104, such as the time it takes the learner 102 to answer a question, the number of times the learner 102 requests a correction to a selected answer, the speed at which questions are presented to the learner 102, and/or the position/location of the question on the learning device 104.

The learning engagement state recognition engine 130 may take this information and may store it in the ANN 132, which may include a data repository for the neural network 132a. Generally, a neural network may be thought as a set of adaptive weights between associated notes that are tuned by a learning algorithm, and that may be able to approximate the capability of nonlinear functions of outputs based on given inputs. In this disclosure, the ANN 132 may be able to, among other things, learn to associate a variety of inputs and to associate them with a particular current learning state of a learner 102. In other embodiments, AI techniques other than an ANN 132 may be used.

In embodiments, the data that may be received from real-time learner sensing data 110, learner data 124, environmental data 122, and/or instruction module 106 data may be identified in terms of: (1) appearance features, (2) contextual features, and (3) performance features of a learner 102. In embodiments these may be referred to as categorical sets. Data summarized from these three categorical sets may then be provided to the learning engagement state recognition engine 130 to either determine the learner's 102 current learning engagement state, and/or to update the ANN 132 associated with the learning engagement state recognition engine 130. In embodiments, a principal of categorizing features in this way may be that various observable task and hidden states relate to student engagement. In other words, a student's engagement state at a given time may be influenced by the context and the student state early on, which in turn may influence the student's appearance and performance now. In embodiments using this taxonomy appearance, context and performance features: appearance features correspond to real-time learner sensing data 110, performance features correspond to learner data 124, and context features may refer to environmental data 122, learner data 124, and data from the instruction module 106. Data presented in this way and associated with an identified learner engagement state may be used to train, calibrate, or update the ANN 132 by the learning state recognition engine 130.

In embodiments related to appearance features, the real-time learner sensing data 110, associated with learner 102 appearance feature identification, may include not only raw data captured from the sensing devices 108, but may also process this data, for example by the real-time learner sensing data 110 module, and provide different levels of information to the learning engagement state recognition engine 130. This information may include information captured per video frame, per video segment, and/or per a temporal window. For example: at the first level, the attributes of the learner 102 that are identified may include: a rectangle of the face detected, one of seventy-eight facial landmarks, head pose information (e.g. yaw, pitch, and roll), face tracking confidence level, and/or facial expression intensity values. At a second level, the attributes of the learner 102 that are identified may include three-dimensional head motion (velocity, acceleration, total energy, etc.), head pose and angular motion, and/or facial expression feature values. At a third level, attributes of the learner 102 may include per-segment features such as total motion, total energy, duration, peak value, and still interval duration. At a fourth level, the previous data may be used to determine certain behavioral patterns such as posture (sitting up straight, leaning forward, leaning back, sunk in chair), motion patterns (forward-backward nodding, left-right shaking), head-gaze direction (looking up (thinking), looking down, looking away (distracted)), facial displays (eye closure, furled eyebrows, a blink, and/or yawn), and/or head-hand pose displays (leaning on hand, or scratching head).

In embodiments related to contextual features, environmental data 122, learner data 124, and data from the instruction module 106 may be used to identify contextual features. A nonexclusive list of contextual features in these embodiments may include: learner age, learner gender, session type (assessment session or instructional video) time of day, exercise number in the current assessment session, current trial number (number of attempts) within the current question, lighting level, noise level, mouse location (in an x-y-coordinate system), the exercise number in the session, the session number, the duration of the current instructional video, the window number within the current instruction video or assessment session, average time spent on the question with all of its attempts, average number of hints used for this question with all its attempts, average number of trials until success for this question, video speed, whether subtitles are used, and/or the current trial number (number of attempts) so far from the beginning of the session.

In embodiments related to performance features, instruction module 106 data may be used to identify performance features. A nonexclusive list of performance features these embodiments may include: the time spent on an attempt, a grade (e.g. one equals success and zero equals fail), the time spent on question ranking relative to other learners, the total number of hints used for this question ranking relative to other learners, the number of trials until success ranking relative to other learners, which trial did the learner 102 succeed in, the number of hints used at the current attempt, the total time spent on a question with all of its attempts, the total number of hints used on the question with all of its attempts, the total number of hints requested so far from the beginning of the session, the number of current attempts failed after a hint was used (e.g., zero equals no, one equals yes), the percent of all past attempts that were correct in the current assessment session, the number of the last five problems that used hints, the total number of two wrong attempts in a row across all the problems in the current assessment session, the number of the last five attempts that were wrong, the number of the last eight attempts that were wrong, the total number of wrong first attempts from the beginning of the session, the total time spent on first attempts across all problems in the current assessment session, and/or the total time spent across all problems divided by the percent of all past attempts that were correct in the current assessment session.

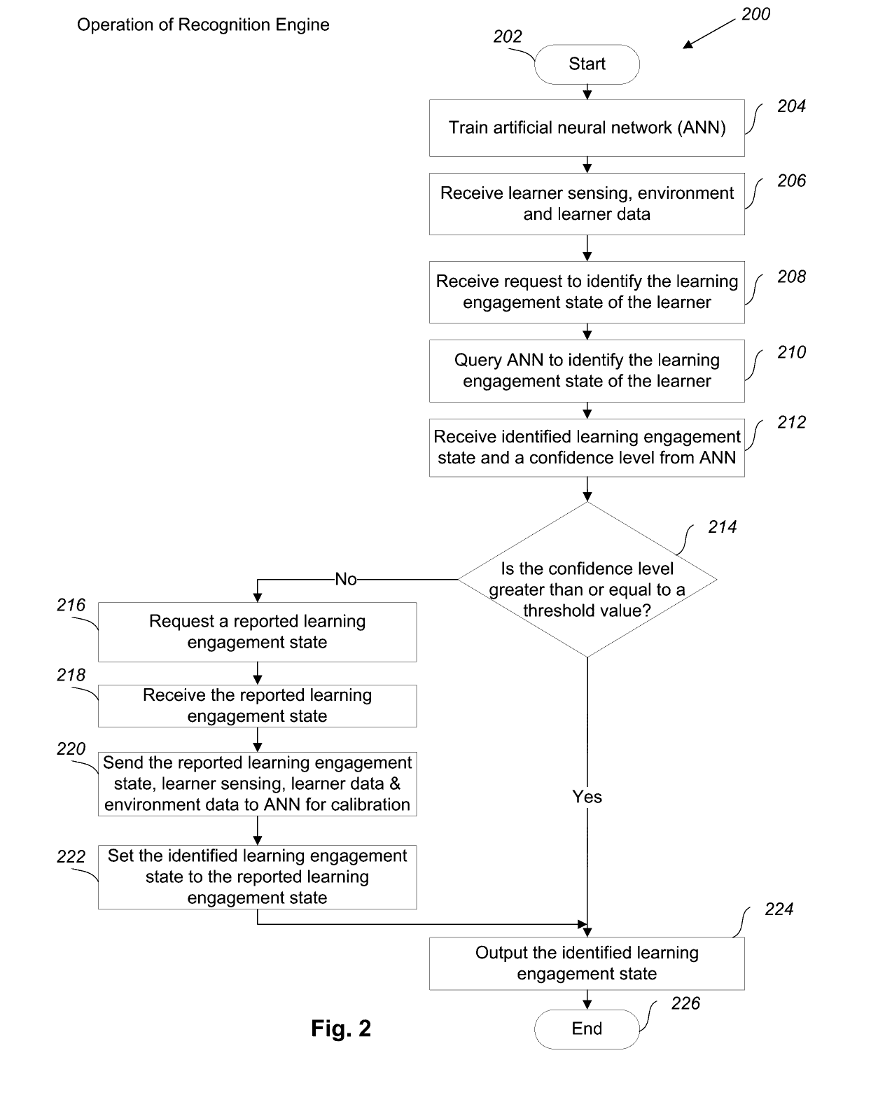

Referring now to FIG. 2, wherein a flow diagram illustrating a method for an embodiment of the operation of a learning engagement state recognition engine may be shown. In embodiments, this method may be practiced on the learning engagement state recognition engine 130 of FIG. 1.

The method may start at block 202.

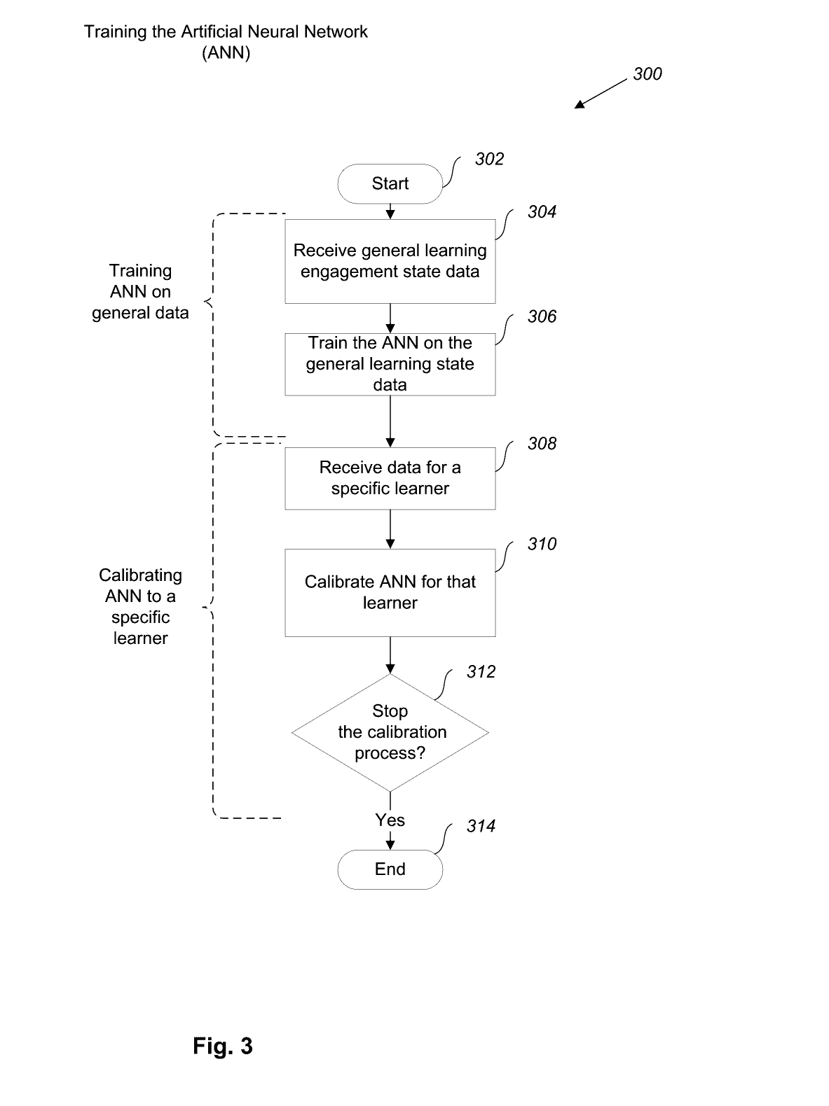

At block 204, the ANN 132 may be trained. Embodiments of this are further described in FIG. 3. In embodiments, the ANN 132 may be initially trained into a generic model using broad-based learner data and observed learner engagement states from a broad sample of learners. In embodiments, this data may be collected and labeled during a prior data collection phase. In these embodiments, initial identifications of learner engagement states may be based on the broad norm of the generic model and not reflect the individual learner engagement states of a particular learner. In embodiments, generic model represented by the ANN 132 may be subsequently calibrated to one or more specific learners 102 as further described in FIG. 3. This may enable the ANN 132 to identify a learner engagement state tailored to the specific unique culture and/or learning style of a particular learner 102, given data about the learner.

At block 206, learner sensing, environment, and learner data may be received. As described above in FIG. 1, this data may include real-time learner sensing data 110, environmental data 122, and learner data 124 about one or more particular learners 102. In embodiments, this data may be received in real time, on a regular but intermittent basis, or upon demand, for example when a request for the identification of a learner engagement state is made.

At block 208, a request for the identification of a learner engagement state may be received. This request may be related to the data provided in block 206, for a learner 102. In embodiments, this request may come from the instruction module 106 as a part of the process of determining what to display to learner 102 on educational device 104.

At block 210, the ANN 132 may be queried to identify the learner engagement state of the learner 102. In embodiments, this query may include one or more of the sensing, environment, and/or learner data received in block 206 above. This query may take the form of a function call to the ANN 132, may take the form of a remote procedure call, may take the form of a service invoked by an HTTP header with function parameters, or may take some other form.

At block 212, the learner engagement state for the queried learner 102 and the confidence level may be received from ANN 132. In embodiments, the learning engagement state may be one of on-task, off-task, highly motivated, calm, bored, or confused/frustrated. The confidence level may represent the likelihood, determined by the learning engagement state recognition engine 130 from the ANN 132, that the identified learning engagement state for learner 102 accurately represents the actual current learning engagement state of the learner 102.

At block 214, a determination may be made on whether the confidence level associated with the real-time learning state provided by the ANN 132 is greater than or equal to a threshold value. If the confidence level associated with the real time learning state is greater than or equal to a threshold value, then at block 224 the method outputs the identified learning engagement state, and the method 200 may end at block 226.

Otherwise, at block 216 a reported learning engagement state of a learner may be requested. In embodiments, this request may be made by the report learner engagement state module 122, or through some other channel, for example, on behalf of the instruction module 106.

At block 218, the reported learning engagement state is received. In embodiments, the learning state module 122 may request that a human labeler 120 who is observing learner 102 indicate the learner's current learning engagement state. In other embodiments, the learner 102 may be asked to self-report the learner's engagement state either verbally, through gestures, or through the input/output capability of educational device 104. In embodiments, the function of the report learner engagement state module 122 may be included as a part of instruction module 106.

At block 220, the received learning engagement state, learner sensing, learner data and environment data may be sent to the ANN 132 for calibration and/or updating of the ANN 132 with respect to learner 102.

At block 222, the identified learning engagement state may be set to the reported learning engagement state for learner 102.

At block 224, the method may output the identified learning engagement state.

At block 226, the method 200 may end.

Referring now to FIG. 3, wherein a flow diagram illustrating a method for an embodiment of the operation of an artificial neural network, as shown on FIG. 1 call out 132, may be shown.

The method 300 may start at block 302.

At block 304 general learning engagement state data may be received by the artificial neural network (ANN) 132. In embodiments, this may be referred to as building a generic artificial neural network model, or training an artificial neural network model. In embodiments, this data may consist of real-time learner sensing data 110, environmental data 122, and/or learner 414

data 124 associated with identifying a learner engagement state that has been collected from past learner experiences. In embodiments, this data may be derived from hypothetical combinations of learner sensing data, environmental data, and/or learner data and a resulting learner engagement state that the data might indicate. For example, a furled brow may generally indicate confusion. In either of these examples, the data and resulting learner engagement state may not be associated with any particular learner, rather may be associated with learners in general.

At block 306, the ANN 132 is trained on the general learning state data collected in the previous block. In embodiments, this block may result in a trained generic/generalized model that does not embody any unique characteristics related to a particular learner 102. In embodiments, this may be referred to as training a generic artificial neural network model, or training a general artificial neural network model. In embodiments, requesting a learner engagement state at this stage of the artificial neural network model for a particular learner 102 may only produce a general learner engagement state, and not one that is calibrated or personalized to any particular learner 102.

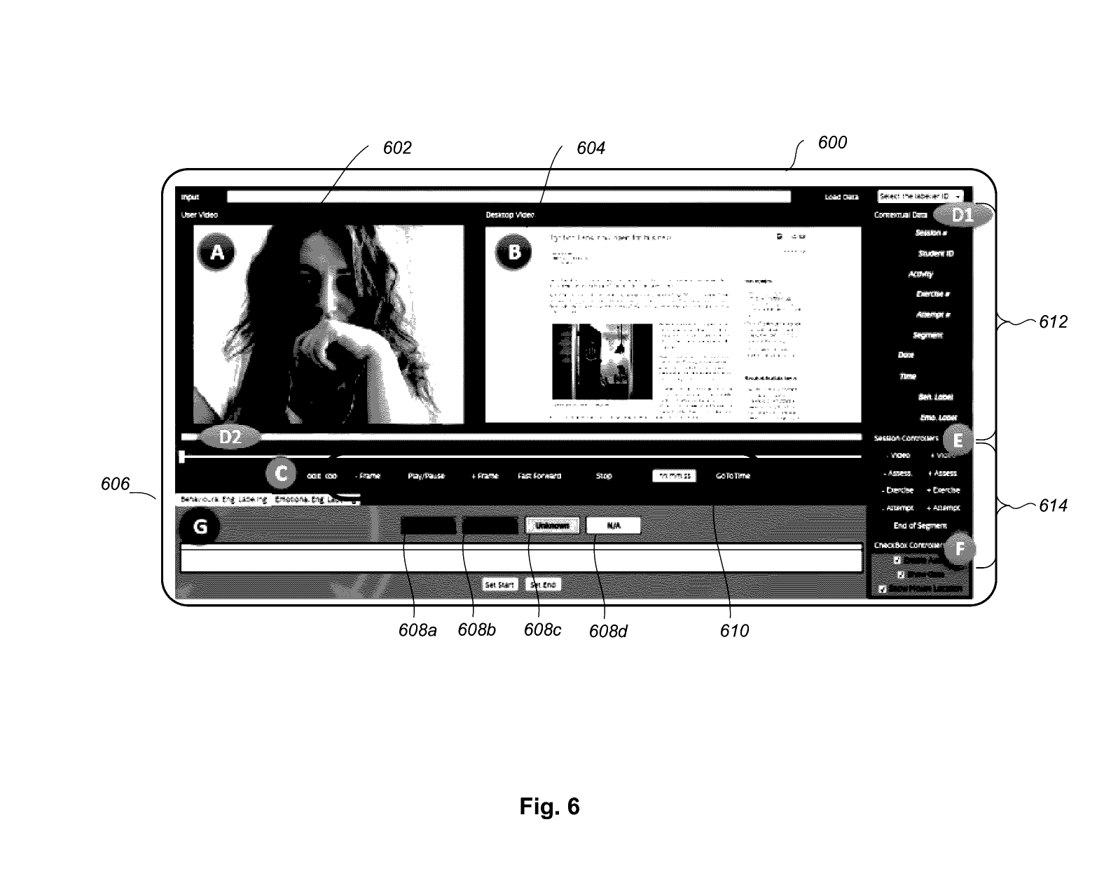

At block 308, data for a specific learner may be received, for example data that may be specific to learner 102. In embodiments, this data may include real-time learner sensing data 110, environmental data 122, learner data 124, and the reported learner state 122. The reported learner state may come from a labeler 120 observing the learner 102 either directly or through a video and/or audio feed at a remote location and may use a labeling tool with an interface as shown in FIG. 6. The reported learner state may also come from the learner 102 self-reporting the learner's state by using educational device 104, or communicating in another way such as talking to the labeler 120. In embodiments, data for a specific learner 102 may be identified by giving a special calibration test, or presenting the learner with specially designed questions that will lead the learner into predictable learner engagement states that may then be observed. For example, a test that is known to be deliberately difficult or unclear and result in a learner engagement state of off-task may be used to identify the learner 102 unique physical responses that indicate an off-task engagement state for that learner.

At block 310, the data received at block 308 may be used to calibrate/train the ANN 132 for that particular learner 102. In embodiments, the ANN 132 may be updated, for example by adding additional nodes and/or adjusting the weights or other relationships between the nodes within the ANN 132.

At block 312, a determination may be made on whether the calibration process is to stop. If the calibration process is to stop, for example if the special calibration test described at block 308 is completed, then the method 300 may end at block 314.

Otherwise, if the calibration process is not to stop, then the method goes to block 308. In embodiments, this additional data may be related to the same learner 102, or to a different learner to which the ANN 132 is also to be calibrated.

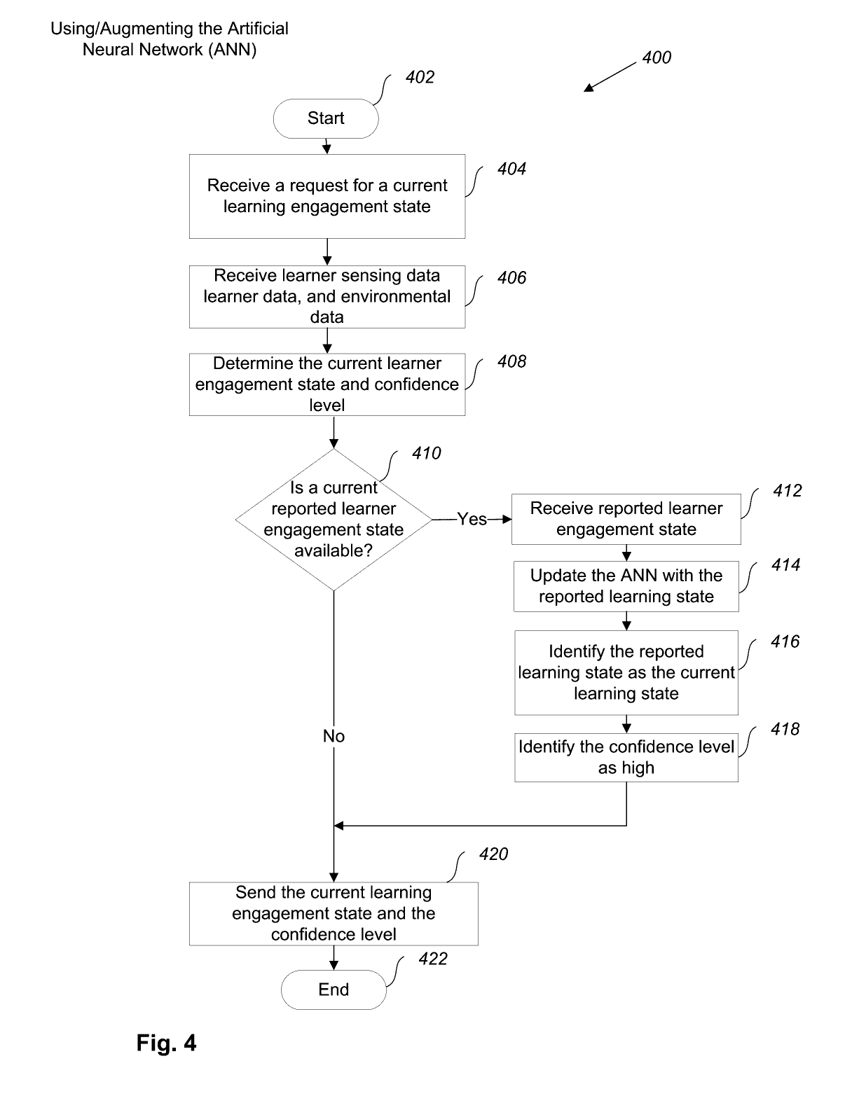

Referring now to FIG. 4, wherein a flow diagram illustrating a method for operating an artificial neural network, as shown on FIG. 1 call out 132, may be shown.

The method 400 may start at block 402.

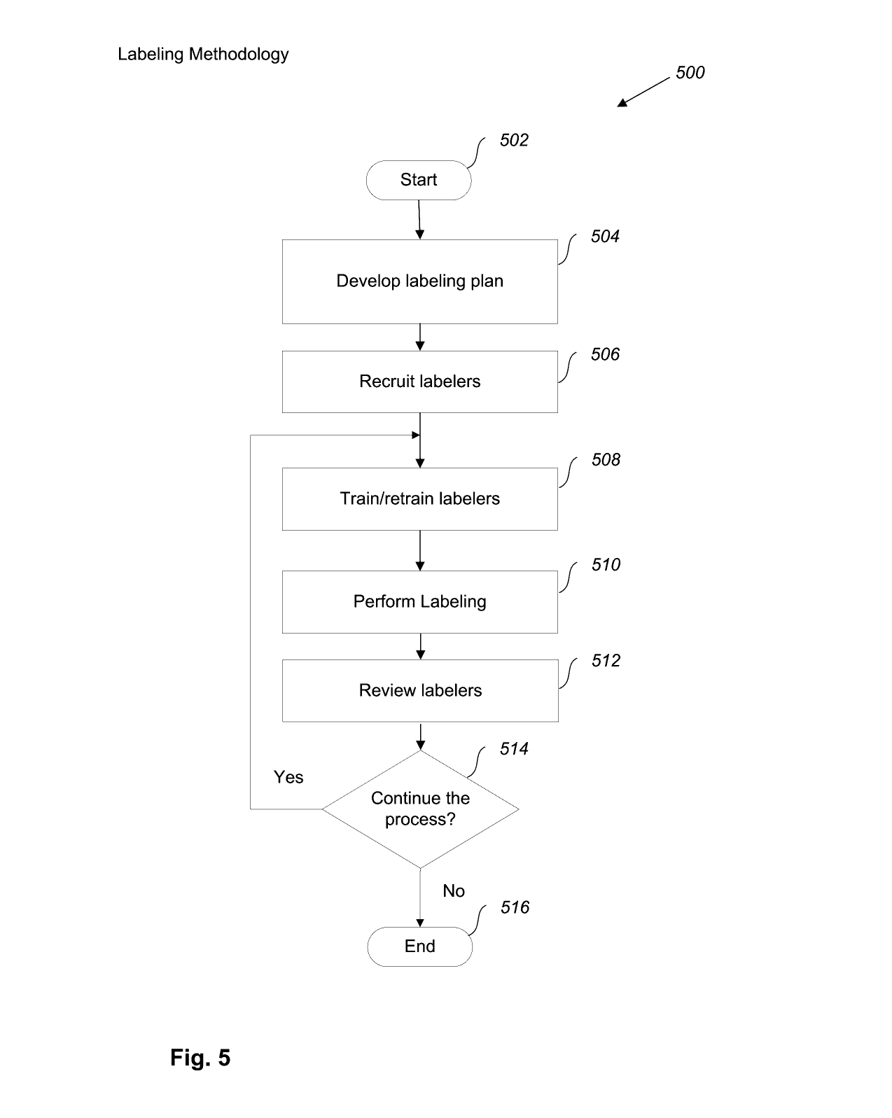

At block 404, a request for a learner engagement state may be received. In embodiments, the request may come from the instruction module 106 as it determines how to change the interface and/or lesson flow presented to learner 102 on educational device 104. In other embodiments, the request may come from evaluators of potential labelers 120 as these potential labelers are being evaluated and/or trained, as described with respect to FIG. 5.

At block 406, learner sensing data, learner data and environmental data is received. In embodiments, this data may come from the real-time learner sensing data module 110.

At block 408 the learner engagement state and confidence level is determined. In embodiments, the data received at block 406 may be sent to the artificial neural network (ANN) 132 to determine the learner engagement state and confidence level that the determined learner engagement state matches the actual learner engagement state. In embodiments, the ANN 132 may be already calibrated with data for the specific learner 102, for example as referred to in FIG. 5, and is able to provide a more accurate learning engagement state. This may be in contrast to an ANN 132 being only trained with generic data and not calibrated to a specific learner. In embodiments, the confidence level may be a real number ranging from zero to one, zero meaning no confidence and one meaning the highest confidence (absolute certainty) that the learner 102 actual learning engagement state is the same as the ANN 132 indicated learning engagement state.

At block 410 a determination may be made on whether a current reported learner engagement state is available. If the current reported learner engagement state is not available, then at block 420 the current learner engagement state and the confidence level may be sent, and at block 422 the method 400 may end.

Otherwise, if the current reported learner engagement state is available, then at block 412 the reported learner engagement state is received. In embodiments, this learner engagement state may be received from a labeler 120 who is observing the learner 102. In other embodiments, the learner engagement state may be self-reported by the learner 102 when prompted by the educational device 104. In embodiments, a request may be sent to the report learner engagement state module 122, which may then request the learner engagement state from either from the labeler 120 or from the learner 102.

At block 414, the ANN 132 may be updated with the reported learner engagement state. In embodiments, this may include sending the sensing, learner and/or environmental data received in block 406 to the ANN 132.

At block 416, the reported learning engagement state may be identified as the current learning engagement state.

At block 418, the confidence level may be identified as high. In some embodiments, reported learner engagement states may be considered highly reliable, which may be reflected by setting the confidence level to a numerical value at or near one.

At block 420, the current learning engagement state and the confidence level may be sent.

At block 422, the method may end.

Referring now to FIG. 5, wherein a method for labeling learner engagement states may be shown. This method may be implemented, in the module report learner engagement state 122 module shown in FIG. 1.

In embodiments, the method may be used to identify and train labelers, for example the labeler 120 as depicted in FIG. 1, who observe a learner 102 and are able to accurately label and report the learner 102 learning engagement state. In embodiments, this method may be broken into three general phases: pre-labeling, labeling, and post-labeling.

In embodiments, labeling may be divided into behavior labeling and emotional labeling. Behavior labeling may be related to the physical interaction between the learner 102 and the education device 104. Behavioral labels may include, but are not limited to, on-task, off-task, unknown, and/or not available. Emotional labeling may be related to the current emotional state of the learner 102. Emotional labels may include, but are not limited to, highly motivated (the learner 102 was concentrating very hard, is enjoying the work, and is highly interested), calm (the learner is following the task on the educational device 104, but is not very focused or excited about it), bored (yawning, sleepy, doing something else, or not interested at all), confused/frustrated (asking questions to a teacher, angry, disgusted, or annoyed), unknown (cannot be decided), and/or not available (if the lesson content that may be displayed on the educational device 104 is not open).

In embodiments, the identification of a learner engagement state, implemented by artificial intelligence means including an artificial neural network (ANN) 132, may require a rigorous methodology to ensure accuracy in labeling a learning engagement state to ensure the highest quality data is used to train and/or calibrate the ANN 132. This rigorous methodology may include selecting the labelers, training labelers, and procedures to receive learner engagement state labels coming from multiple labelers observing a learner 102. In embodiments, the labeling procedure may be a subjective and time-consuming task, and may be an extremely challenging and difficult task for non-experts. Although recruiting labelers from the educational or psychological career areas may provide a substantial improvement in the accuracy of labeling, in embodiments the labelers should have sufficient information and training for them to consistently and accurately identify the correct learner engagement state. Therefore, to facilitate the labeling process, a labeling tool, for example as shown in FIG. 6, may be used in both the training of labelers as well as labelers performing the labeling process.

The method 500 may start at block 502.

At block 504, a labeling plan may be developed. In embodiments this plan may include one or more components including: (1) prepare a step-by-step labeler training and evaluation procedure; (2) create operational definitions and a sample of examples for each label; (3) select meaningful information to evaluate; (4) perform a literature search on which labels are to be used in the labeling process; (5) have researchers label the data; (6) prepare relevant training materials; and (7) define requirements for labelers, for example educational or professional backgrounds labelers may have.

At block 506, labelers may be recruited. In embodiments, this may also include labeler recruitment, training, and evaluation. Specifically, embodiments may include one or more components including: (1) based on requirements for labeling and/or observing, recruiting a prospect of a group of labelers; (2) training prospective labelers; (3) select meaningful data to evaluate; (4) have prospective labelers label the data; (5) evaluate agreement levels among the labelers; and/or (6) select a final group of labelers.

At block 508, labelers may be trained. In embodiments, this may also include: (1) training labelers on the labeling process; (2) having labelers practice labeling learner sensing data; (4) having labelers enter questions related to a labeling process into a shared document; (5) having researchers meet and discuss the questions in the evaluation session and address these questions with the labelers in a subsequent labeler training session; and/or (6) having labelers fill in a questionnaire regarding their overall labeling experience.

At block 510, labeling may be performed by the labelers. In embodiments, this may be done by giving a labeler 120 locational proximity and direct visual access to one or more learners 102, or by using camera 108a, microphone 108b, or other learner sensing equipment 108 to send video or audio to the labeler's 120 remote location.

At block 512, labelers may be reviewed. In embodiments, this may include evaluating labelers' overall agreement, where more than one labeler is labeling a learner 102 engagement state.

At block 514, a determination may be made on whether the process is to be repeated. If the process is to be repeated, then the method may continue to block 508.

Otherwise, if the process is not to be repeated, the method may end at block 516.

Referring now to FIG. 6, wherein a diagram illustrating an example user interface for a program that may be used by labelers to label learner engagement states, according to various embodiments, is shown.

In embodiments, the labeling tool 600 may allow a labeler 120 to identify and label the current learning engagement state of a learner 102 who is not in proximity of the labeler. In embodiments, the labeler 120 may receive visual or auditory information from learner sensing equipment 108. In embodiments, this data may be retrieved by the Intel® Perceptual Computing SDK capturing utility (PerC) (not shown) from the instruction module 106 or from the user interface on learning device 104. In embodiments, the head or face of learner 102 may be shown in window 602, and the education device 104 user interface, with which the learner is interacting, may be presented in window 604. In embodiments, these two windows may be synchronized so that they may display substantially simultaneously the learner 102 and the learner's interaction with the education device 104.

In embodiments, a labeler 120 may use pre-defined labels for identifying a particular learner 102 learning engagement state. In embodiments, a labeler 120 may select the behavioral labeling button 606, which may cause sub buttons associated with behavioral labels to appear 608a, 608b, 608c, 608d. The labeler may then select the appropriate learner 102 engagement state. Identifying an emotional state may be done in a similar fashion. In addition, in embodiments, window 602 and window 604 may present substantially simultaneous activities that may have occurred in the past and have been recorded. The labeler 120 may wish to identify and label the learner 102 learning engagement state in order to calibrate and/or update the ANN 132 for the learner. In these embodiments, buttons 610 may be used to move around in the learner/educational device time sequence recording. In other embodiments, keyboard characters, a mouse, tablet or other input device may be used to move around in the time sequence recording.

Contextual data, as referred to above, may be shown and or modified using the controls 612. In addition, Windows button controllers 614 may be used to jump to the next/previous video segment, assessment segment, exercise in the assessment segment, and attempt in the exercise, and to jump to the end of each segment. In addition, mouse location information or mouse tics may also be included in the learner engagement state analysis, in addition to where the learner 102 eyes look on the education device 104.

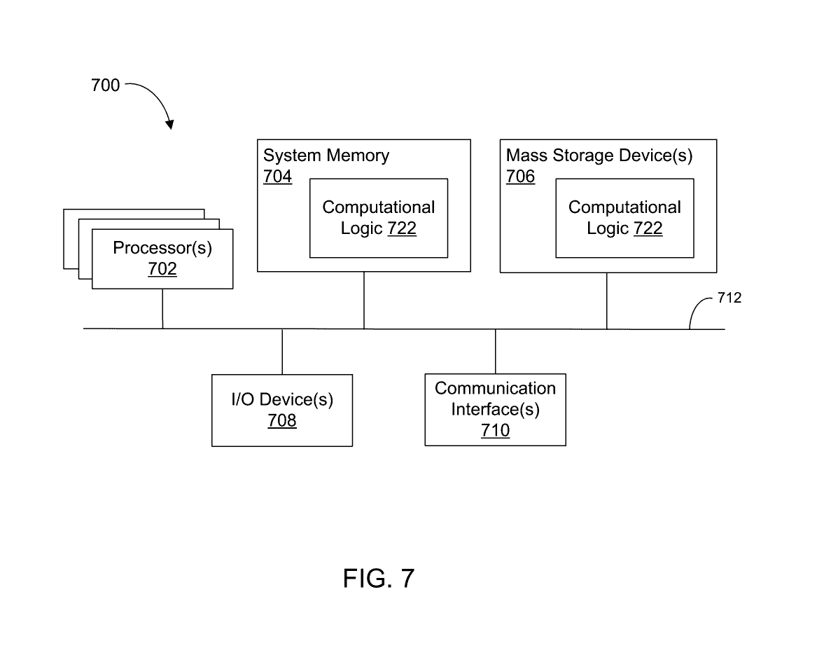

Referring now to FIG. 7, wherein an example computing device suitable to implement a learning engagement state recognition engine 130 in accordance with various embodiments, is illustrated. As shown, computing device 700 may include one or more processors or processor cores 702, and system memory 704. In embodiments, multiple processor cores 702 may be disposed on one die. For the purpose of this application, including the claims, the terms “processor” and “processor cores” may be considered synonymous, unless the context clearly requires otherwise. Additionally, computing device 700 may include mass storage device(s) 706 (such as diskette, hard drive, compact disc read-only memory (CDROM), and so forth), input/output (I/O) device(s) 708 (such as display, keyboard, cursor control, and so forth), and communication interfaces 710 (such as network interface cards, modems, and so forth). In embodiments, a display unit may be touch screen sensitive and may include a display screen, one or more processors, storage medium, and communication elements. Further, it may be removably docked or undocked from a base platform having the keyboard. The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage device(s) 706 may be employed to store a working copy and a permanent copy of programming instructions implementing the operations described earlier, e.g., but not limited to, operations associated with learning engagement state learning recognition engine 130, instruction module 106, and/or learner engagement state reporter 122, generally referred to as computational logic 722. The various operations may be implemented by assembler instructions supported by processor(s) 702 or high-level languages, such as, for example, C, that may be compiled into such instructions.

The permanent copy of the programming instructions may be placed into permanent mass storage device(s) 706 in the factory, or in the field, through, for example, a distribution medium (not shown), such as a compact disc (CD), or through communication interface 710 (from a distribution server (not shown)). That is, one or more distribution media having an implementation of a learning engagement state recognition engine 130, instruction module 106, and/or learner engagement state reporter 122, may be employed to distribute the learning engagement state recognition engine 130, instruction module 106, and/or learner engagement state reporter 122, and program various computing devices.

The number, capability, and/or capacity of these elements 710-712 may vary, depending on the intended use of example computing device 700, e.g., whether example computer 700 is a smartphone, tablet, ultra-book, laptop, or desktop. The constitutions of these elements 710-712 are otherwise known, and accordingly will not be further described.

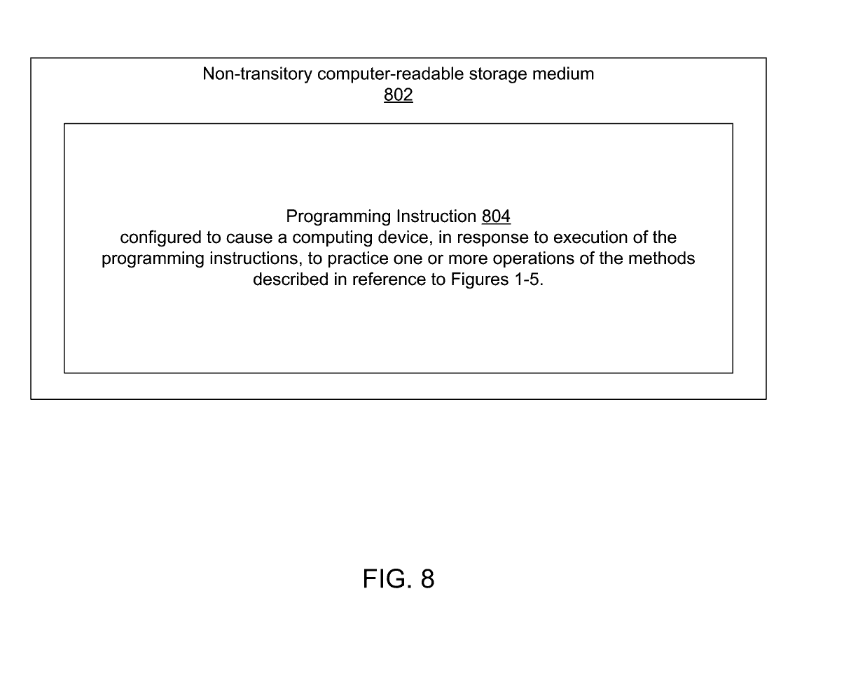

FIG. 8 illustrates an example non-transitory computer-readable storage medium having instructions configured to practice all or selected ones of the operations associated with learning engagement state recognition engine 130, earlier described, in accordance with various embodiments. As illustrated, non-transitory computer-readable storage medium 802 may include a number of programming instructions 804. Programming instructions 804 may be configured to enable a device, e.g., computing device 700, in response to execution of the programming instructions, to perform one or more operations of the processes described in reference to FIGS. 1-5. In alternate embodiments, programming instructions 804 may be disposed on multiple non-transitory computer-readable storage media 802 instead. In still other embodiments, programming instructions 804 may be encoded in transitory computer-readable signals.

Referring back to FIG. 7, for one embodiment, at least one of processors 702 may be packaged together with computational logic 722 (in lieu of storing in memory 704 and/or mass storage 706) configured to perform one or more operations of the processes described with reference to FIGS. 1-6. For one embodiment, at least one of processors 702 may be packaged together with computational logic 722 configured to practice aspects of the methods described in reference to FIGS. 1-6 to form a System in Package (SiP). For one embodiment, at least one of processors 702 may be integrated on the same die with computational logic 722 configured to perform one or more operations of the processes described in reference to FIGS. 1-6. For one embodiment, at least one of processors 602 may be packaged together with computational logic 722 configured to perform one or more operations of the process described in reference to FIGS. 1-6 to form a System on Chip (SoC). Such an SoC may be utilized in any suitable computing device.

For the purposes of this description, a computer usable or computer-readable medium can be any apparatus that can contain, store, communicate, propagate, or transport the program for use by or in connection with an instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read-only memory (CD-ROM), compact disk-read/write (CD-R/W), and digital video disk (DVD).

### EXAMPLES

Example 1 is an apparatus to provide a computer-aided educational program, comprising: one or more processors; a receive module, to be operated on the one or more processors, to receive indications of interactions of a learner with the educational program and to receive indications of physical responses of the learner collected substantially simultaneously as the learner interacts with the educational program; a learning state identification module, to be operated on the one or more processors, to identify a current learning state of the learner based at least in part on the indications of interactions and indications of physical responses; and an output module, to be operated on the one or more processors, to output the current learning state of the learner; wherein the current learning state of the learner is used to tailor computerized provision of the education program.

Example 2 may include the subject matter of Example 1, wherein the learning state identification module is further to: provide, to an artificial neural network associated with the learner, the received indications of interactions and the received physical responses of the learner; receive, from the artificial neural network, a proposed learning state of the learner and a confidence level of the proposed learning state based on the provided indications; and when the confidence level is above a threshold value, identify the received proposed learning state of the learner as the current learning state of the learner.

Example 3 may include the subject matter of Example 2, wherein the artificial neural network is on the same or a different apparatus.

Example 4 may include the subject matter of Example 1, wherein the learning state identification module is further to: provide, to an artificial neural network associated with the learner, the received indications of interactions and the received physical responses of the learner; receive, from the artificial neural network, a proposed learning state of the learner and a confidence level of the proposed learning state based on the provided indications; and when the confidence level is not above a threshold value: send to a learning state observer a request for the current learning state of the learner, receive, from the learning state observer, an indication of the current learning state of the learner, and send an update request to the artificial neural network, the request including the received current learning state of the learner, the indications of interactions of the learner and the indications of physical responses of the learner.

Example 5 may include the subject matter of Example 4, wherein the learning state observer is a selected one of the learner or a human observing the learner.

Example 6 may include the subject matter of Example 1, wherein the receive module is to receive the indications of the physical responses of the learner from a human observing the learner or from a physical response capture device associated with the learner.

Example 7 may include the subject matter of Example 1, wherein the current learning state of the learner is identified by the learner.

Example 8 may include the subject matter of Example 1, wherein the current learning state of the learner is a behavioral state or an emotional state.

Example 9 is an apparatus to implement a neural network comprising : one or more processors; a neural-network management module, to be operated on the one or more processors, to manage the artificial neural network; a receive module, to be operated on the one or more processors, to: receive indications of interactions of a plurality of learners with an educational program, receive indications of physical responses of each of the plurality of learners collected substantially simultaneously as the each of the plurality of learners interact with the educational program, and receive indications of a current learning state of at least one of the plurality of learners associated with the received indications of physical responses and the received indications of interactions with the education device of the each of the plurality of learners; a neural-network training module, to be operated on the one or more processors, to train the artificial neural network based upon the received indications; a request receiver module, to be operated on the one or more processors, to receive a request for a current learning state of a selected learner, the request including an indication of interactions of a learner with the educational device and an indication of physical responses of the learner collected substantially simultaneously as the learner interacts with the educational program; and an output module, to be operated on the one or more processors, to: in response to the received request, determine a current learning state and a confidence level for the determined current learning state from the artificial neural network; and output the determined current learning state and the confidence level of the current learning state.

Example 10 may include the subject matter of Example 9, wherein the confidence level is a scalar or a vector.

Example 11 is a method for computerized assisted learning, comprising: receiving, by a learning state engine operating on a computing system, indications of interactions of a learner with a computerized educational program presented through a learning device; receiving, by the learning state engine, indications of physical responses of the learner collected substantially simultaneously as the learner is interacting with the educational program; identifying, by the learning state engine, a current learning state of the learner, based at least in part on the indications of interactions and indications of physical responses; and outputting, by the learning state engine, the current learning state of the learner; wherein the current learning state of the learner is used to tailor computerized provision of the education program.

Example 12 may include the subject matter of Example 11, wherein identifying a current learning state of the learner includes: providing, by the learning state engine, to an artificial neural network associated with the learner, the received indications of interactions and the received physical responses of the learner; receiving, by the learning state engine, from the artificial neural network, a proposed learning state of the learner and a confidence level of the proposed learning state based on the provided indications; and when the confidence level is above a threshold value, identifying, by the learning state engine, the received proposed learning state of the learner as the current learning state of the learner.

Example 13 may include the subject matter of Example 11, wherein identifying a current learning state of the learner includes: providing, by the learning state engine, to an artificial neural network associated with the learner, the received indications of interactions and the received physical responses of the learner; receiving, by the learning state engine, from the artificial neural network, a proposed learning state of the learner and a confidence level of the proposed learning state based on the provided indications; and when the confidence level is not above a threshold value: sending, by the learning state engine, to a learning state observer, a request for the current learning state of the learner, receiving, by the learning state engine, from the learning state observer, an indication of the current learning state of the learner, sending, by the learning state engine, an update request to the artificial neural network, the request including received indications of the current learning state of the learner, indications of interactions of the learner and the indications of physical responses of the learner, and identifying, by the learning state engine, the received current learning state of the learner.

Example 14 may include the subject matter of Example 13, wherein the learning state observer is the learner self-assessing the learner's learning state or a human observing the learner and assessing the learner's learning state.

Example 15 may include the subject matter of Example 14, further comprising: facilitating, by the learning engine, in training the human observer; and facilitating, by the learning engine, in evaluating the human observer.

Example 16 may include the subject matter of Example 13, further comprising: calibrating, by the learning state engine, the artificial neural network associated with the learner, wherein calibrating the artificial neural network associated with the learner includes: receiving, by the learning state engine, an indication of an interaction with an educational program, an indication of substantially simultaneously physical responses, and an indication of a substantially simultaneous learning state for at least one other learner; and sending, by the learning state engine, a request to update the artificial neural network, the request including the received indications for the at least one other learner.

Example 17 may include the subject matter of any of Examples 11-16, wherein a current learning state is a behavioral state or an emotional state.

Example 18 may include the subject matter of Example 17, wherein a behavioral state is a selected one of on-task, off-task, or away from desk.

Example 19 may include the subject matter of Example 17, wherein an emotional state is a selected one of highly motivated, calm, bored, or confused/frustrated.

Example 20 may include the subject matter of Example 16, wherein receiving an indication of the substantially simultaneous physical response of the learner is from a human observing the learner or from a physical response capture device associated with the learner.

Example 21 may include the subject matter of Example 20, wherein a physical response capture device associated with the learner is a selected one of a camera, video recorder, microphone, motion detector, vital statistics monitor or an environment monitor.

Example 22 may include the subject matter of Example 21, wherein receiving indications of physical responses includes receiving indications of learner activity or receiving indications of the learner environment.

Example 23 may include the subject matter of Example 22, wherein receiving indications of learner activity includes receiving from a facial expression analysis engine operating on the same or a different computer system, indications of learner facial-motion, indications of learner eye tracking, or indications of learner posture.

Example 24 may include the subject matter of Example 22, wherein receiving indications of learner activity includes receiving from a learner proximity/gesture analysis engine operating on the same of a different computer system, indications of learner gestures, indications of learner proximity to an education device hosting the educational program, indications of learner sounds, or indications of learner words spoken.

Example 25 may include the subject matter of Example 22, wherein receiving indications of the learner environment includes receiving from environmental sensors indications of lighting levels, ambient noise, or ambient temperature of an interior space where the learner is learning, time of day, or weather outside the interior space.

Example 26 is one or more computer-readable media comprising instructions that cause a computing device, in response to execution of the instructions by the computing device, to: receive, by a learning state engine operating on a computing system, indications of interactions of a learner with a computerized educational program presented through a learning device; receive, by the learning state engine, indications of physical responses of the learner collected substantially simultaneously as the learner is interacting with the educational program; identify, by the learning state engine, a current learning state of the learner, based at least in part on the indications of interactions and indications of physical responses; and output, by the learning state engine, the current learning state of the learner; wherein the current learning state of the learner is used to tailor computerized provision of the education program.

Example 27 may include the subject matter of Example 26, wherein identify a current learning state of the learner includes: provide, by the learning state engine, to an artificial neural network associated with the learner, the received indications of interactions and the received physical responses of the learner; receive, by the learning state engine, from the artificial neural network, a proposed learning state of the learner and a confidence level of the proposed learning state based on the provided indications; and when the confidence level is above a threshold value, identify, by the learning state engine, the received proposed learning state of the learner as the current learning state of the learner.

Example 28 may include the subject matter of Example 26, wherein identify a current learning state of the learner includes: provide, by the learning state engine, to an artificial neural network associated with the learner, the received indications of interactions and the received physical responses of the learner; receive, by the learning state engine, from the artificial neural network, a proposed learning state of the learner and a confidence level of the proposed learning state based on the provided indications; and when the confidence level is not above a threshold value: send, by the learning state engine, to a learning state observer, a request for the current learning state of the learner, receive, by the learning state engine, from the learning state observer, an indication of the current learning state of the learner, send, by the learning state engine, an update request to the artificial neural network, the request including received indications of the current learning state of the learner, indications of interactions of the learner and the indications of physical responses of the learner, and identify, by the learning state engine, the received current learning state of the learner.

Example 29 may include the subject matter of Example 28, wherein the learning state observer is the learner self-assessing the learner's learning state or a human observing the learner and assessing the learner's learning state.

Example 30 may include the subject matter of Example 29, further comprising: facilitate, by the learning engine, training the human observer; and facilitate, by the learning engine, evaluating the human observer.

Example 31 may include the subject matter of Example 28, further comprising: calibrate, by the learning state engine, the artificial neural network associated with the learner, wherein to calibrate the artificial neural network associated with the learner includes: receive, by the learning state engine, an indication of an interaction with an educational program, an indication of substantially simultaneously physical responses, and an indication of a substantially simultaneous learning state for at least one other learner; and send, by the learning state engine, a request to update the artificial neural network, the request to include the received indications for the at least one other learner.

Example 32 may include the subject matter of any of Examples 26-31, wherein a current learning state is a behavioral state or an emotional state.

Example 33 may include the subject matter of Example 32, wherein a behavioral state is a selected one of on-task, off-task, or away from desk.

Example 34 may include the subject matter of Example 32, wherein an emotional state is a selected one of highly motivated, calm, bored, or confused/frustrated.

Example 35 may include the subject matter of Example 31, wherein receive an indication of the substantially simultaneous physical response of the learner is from a human observing the learner or from a physical response capture device associated with the learner.

Example 36 may include the subject matter of Example 35, wherein a physical response capture device associated with the learner is a selected one of a camera, video recorder, microphone, motion detector, vital statistics monitor or an environment monitor.

Example 37 may include the subject matter of Example 36, wherein receive indications of physical responses includes receive indications of learner activity or receive indications of the learner environment.

Example 38 may include the subject matter of Example 37, wherein receive indications of learner activity includes receive from a facial expression analysis engine operating on the same or a different computer system, indications of learner facial-motion, indications of learner eye tracking, or indications of learner posture.

Example 39 may include the subject matter of Example 37, wherein receive indications of learner activity includes receive from a learner proximity/gesture analysis engine operating on the same of a different computer system, indications of learner gestures, indications of learner proximity to an education device hosting the educational program, indications of learner sounds, or indications of learner words spoken.

Example 40 may include the subject matter of Example 37, wherein receiving indications of the learner environment includes receive from environmental sensors indications of lighting levels, ambient noise, or ambient temperature of an interior space where the learner is learning, time of day, or weather outside the interior space.

Example 41 is a computing device to provide a computer-aided educational program, comprising: means for receiving indications of interactions of a learner with an educational program; means for receiving indications of physical responses of the learner collected substantially simultaneously as the learner is interacting with the educational program; means for identifying a current learning state of the learner, based at least in part on the indications of interactions and indications of physical responses; and means for outputting the current learning state of the learner; wherein the current learning state of the learner is used to tailor computerized provision of the education program.

Example 42 may include the subject matter of Example 41, wherein means for identifying a current learning state of the learner includes: means for providing to an artificial neural network associated with the learner, the received indications of interactions and the received physical responses of the learner; means for receiving from the artificial neural network, a proposed learning state of the learner and a confidence level of the proposed learning state based on the provided indications; and when the confidence level is above a threshold value, means for identifying the received proposed learning state of the learner as the current learning state of the learner.

Example 43 may include the subject matter of Example 41, wherein means for identifying a current learning state of the learner includes: means for providing to an artificial neural network associated with the learner, the received indications of interactions and the received physical responses of the learner; means for receiving from the artificial neural network, a proposed learning state of the learner and a confidence level of the proposed learning state based on the provided indications; and when the confidence level is not above a threshold value: means for sending to a learning state observer, a request for the current learning state of the learner, means for receiving from the learning state observer, an indication of the current learning state of the learner, means for sending an update request to the artificial neural network, the request including received indications of the current learning state of the learner, indications of interactions of the learner and the indications of physical responses of the learner, and means for identifying the received current learning state of the learner.

Example 44 may include the subject matter of Example 43, wherein the learning state observer is the learner self-assessing the learner's learning state or a human observing the learner and assessing the learner's learning state.

Example 45 may include the subject matter of Example 44, further comprising: means for facilitating training the human observer; and means for facilitating evaluating the human observer.

Example 46 may include the subject matter of Example 43, further comprising: means for calibrating the artificial neural network associated with the learner, wherein calibrating the artificial neural network associated with the learner includes: means for receiving an indication of an interaction with an educational program, an indication of substantially simultaneously physical responses, and an indication of a substantially simultaneous learning state for at least one other learner; and means for sending a request to update the artificial neural network, the request including the received indications for the at least one other learner.

Example 47 may include the subject matter of any of Examples 41-46, wherein a current learning state is a behavioral state or an emotional state.

Example 48 may include the subject matter of Example 47, wherein a behavioral state is a selected one of on-task, off-task, sleeping, or away from desk.

Example 49 may include the subject matter of Example 47, wherein an emotional state is a selected one of a bored, excited, scared, happy or sad.

Example 50 may include the subject matter of Example 46, wherein means for receiving an indication of the substantially simultaneous physical response of the learner includes a human observing the learner or a physical response capture device associated with the learner.

Example 51 may include the subject matter of Example 50, wherein a physical response capture device associated with the learner is a selected one of a camera, video recorder, microphone, motion detector, vital statistics monitor or an environment monitor.

Example 52 may include the subject matter of Example 51, wherein means for receiving indications of physical responses includes means for receiving indications of learner activity or means for receiving indications of the learner environment.

Example 53 may include the subject matter of Example 52, wherein means for receiving indications of learner activity includes means for receiving from a facial expression analysis engine operating on the same or a different computer system, indications of learner facial-motion, indications of learner eye tracking, or indications of learner posture.

Example 54 may include the subject matter of Example 52, wherein means for receiving indications of learner activity includes means for receiving from a learner proximity/gesture analysis engine operating on the same of a different computer system, indications of learner gestures, indications of learner proximity to an education device hosting the educational program, indications of learner sounds, or indications of learner words spoken.

Example 55 may include the subject matter of Example 52, wherein means for receiving indications of the learner environment includes means for receiving from environmental sensors indications of lighting levels, ambient noise, or ambient temperature of an interior space where the learner is learning, time of day, or weather outside the interior space.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

What is claimed is:

1. An apparatus to provide a computer-aided educational program, comprising:
one or more processors;
a receive module, to be operated on the one or more processors, to receive indications of interactions of a learner with the educational program and to receive indications of physical responses of the learner collected substantially simultaneously as the learner interacts with the educational program;
a learning state identification module, to be operated on the one or more processors, to identify a current learning state of the learner based at least in part on the indications of interactions and indications of physical responses; and
an output module, to be operated on the one or more processors, to output the current learning state of the learner;
wherein the current learning state of the learner is used to tailor computerized provision of the education program.

2. The apparatus of claim 1, wherein the learning state identification module is further to:
provide, to an artificial neural network associated with the learner, the received indications of interactions and the received physical responses of the learner;
receive, from the artificial neural network, a proposed learning state of the learner and a confidence level of the proposed learning state based on the provided indications; and
when the confidence level is above a threshold value, identify the received proposed learning state of the learner as the current learning state of the learner.

3. The apparatus of claim 2, wherein the artificial neural network is on the same or a different apparatus.

4. The apparatus of claim 1, wherein the learning state identification module is further to:
provide, to an artificial neural network associated with the learner, the received indications of interactions and the received physical responses of the learner;
receive, from the artificial neural network, a proposed learning state of the learner and a confidence level of the proposed learning state based on the provided indications; and
when the confidence level is not above a threshold value:
send to a learning state observer a request for the current learning state of the learner,
receive, from the learning state observer, an indication of the current learning state of the learner, and
send an update request to the artificial neural network, the request including the received current learning state of the learner, the indications of interactions of the learner and the indications of physical responses of the learner.

5. The apparatus of claim 4, wherein the learning state observer is a selected one of the learner or a human observing the learner.

6. The apparatus of claim 1, wherein the receive module is to receive the indications of the physical responses of the learner from a human observing the learner or from a physical response capture device associated with the learner.

7. The apparatus of claim 1, wherein the current learning state of the learner is identified by the learner.

8. The apparatus of claim 1, wherein the current learning state of the learner is a behavioral state or an emotional state.

9. An apparatus to implement a neural network comprising:
one or more processors;
a neural-network management module, to be operated on the one or more processors, to manage the artificial neural network;
a receive module, to be operated on the one or more processors, to:
receive indications of interactions of a plurality of learners with an educational program,
receive indications of physical responses of each of the plurality of learners collected substantially simultaneously as the each of the plurality of learners interact with the educational program, and
receive indications of a current learning state of at least one of the plurality of learners associated with the received indications of physical responses and the received indications of interactions with the education device of the each of the plurality of learners;
a neural-network training module, to be operated on the one or more processors, to train the artificial neural network based upon the received indications;
a request receiver module, to be operated on the one or more processors, to receive a request for a current learning state of a selected learner, the request including an indication of interactions of a learner with the educational device and an indication of physical responses of the learner collected substantially simultaneously as the learner interacts with the educational program; and
an output module, to be operated on the one or more processors, to:
in response to the received request, determine a current learning state and a confidence level for the determined current learning state from the artificial neural network; and
output the determined current learning state and the confidence level of the current learning state.

10. The apparatus of claim 9, wherein the confidence level is a scalar or a vector.

11. A method for computerized assisted learning, comprising:
receiving, by a learning state engine operating on a computing system, indications of interactions of a learner with a computerized educational program presented through a learning device;
receiving, by the learning state engine, indications of physical responses of the learner collected substantially simultaneously as the learner is interacting with the educational program;
identifying, by the learning state engine, a current learning state of the learner, based at least in part on the indications of interactions and indications of physical responses; and
outputting, by the learning state engine, the current learning state of the learner;
wherein the current learning state of the learner is used to tailor computerized provision of the education program.

12. The method of claim 11, wherein identifying a current learning state of the learner includes:
providing, by the learning state engine, to an artificial neural network associated with the learner, the received indications of interactions and the received physical responses of the learner;
receiving, by the learning state engine, from the artificial neural network, a proposed learning state of the learner and a confidence level of the proposed learning state based on the provided indications; and
when the confidence level is above a threshold value, identifying, by the learning state engine, the received proposed learning state of the learner as the current learning state of the learner.

13. The method of claim 11, wherein identifying a current learning state of the learner includes:
providing, by the learning state engine, to an artificial neural network associated with the learner, the received indications of interactions and the received physical responses of the learner;
receiving, by the learning state engine, from the artificial neural network, a proposed learning state of the learner and a confidence level of the proposed learning state based on the provided indications; and
when the confidence level is not above a threshold value:
sending, by the learning state engine, to a learning state observer, a request for the current learning state of the learner,
receiving, by the learning state engine, from the learning state observer, an indication of the current learning state of the learner,
sending, by the learning state engine, an update request to the artificial neural network, the request including received indications of the current learning state of the learner, indications of interactions of the learner and the indications of physical responses of the learner, and
identifying, by the learning state engine, the received current learning state of the learner.

14. One or more computer-readable media comprising instructions that cause a computing device, in response to execution of the instructions by the computing device, to:
receive, by a learning state engine operating on a computing system, indications of interactions of a learner with a computerized educational program presented through a learning device;
receive, by the learning state engine, indications of physical responses of the learner collected substantially simultaneously as the learner is interacting with the educational program;
identify, by the learning state engine, a current learning state of the learner, based at least in part on the indications of interactions and indications of physical responses; and
output, by the learning state engine, the current learning state of the learner;
wherein the current learning state of the learner is used to tailor computerized provision of the education program.

15. The computer-readable media of claim 14, wherein identify a current learning state of the learner includes:
provide, by the learning state engine, to an artificial neural network associated with the learner, the received indications of interactions and the received physical responses of the learner;
receive, by the learning state engine, from the artificial neural network, a proposed learning state of the learner and a confidence level of the proposed learning state based on the provided indications; and
when the confidence level is above a threshold value, identify, by the learning state engine, the received proposed learning state of the learner as the current learning state of the learner.

16. The computer-readable media of claim 14, wherein identify a current learning state of the learner includes:
provide, by the learning state engine, to an artificial neural network associated with the learner, the received indications of interactions and the received physical responses of the learner;
receive, by the learning state engine, from the artificial neural network, a proposed learning state of the learner and a confidence level of the proposed learning state based on the provided indications; and
when the confidence level is not above a threshold value:
send, by the learning state engine, to a learning state observer, a request for the current learning state of the learner,
receive, by the learning state engine, from the learning state observer, an indication of the current learning state of the learner,
send, by the learning state engine, an update request to the artificial neural network, the request including received indications of the current learning state of the learner, indications of interactions of the learner and the indications of physical responses of the learner, and
identify, by the learning state engine, the received current learning state of the learner.

17. The computer-readable media of claim 16, wherein the learning state observer is the learner self-assessing the learner's learning state or a human observing the learner and assessing the learner's learning state.

18. The computer-readable media of claim 17, further comprising:
facilitate, by the learning engine, training the human observer; and
facilitate, by the learning engine, evaluating the human observer.

19. The computer-readable media of claim 16, further comprising:
calibrate, by the learning state engine, the artificial neural network associated with the learner, wherein to calibrate the artificial neural network associated with the learner includes:
receive, by the learning state engine, an indication of an interaction with an educational program, an indication of substantially simultaneously physical responses, and an indication of a substantially simultaneous learning state for at least one other learner; and
send, by the learning state engine, a request to update the artificial neural network, the request to include the received indications for the at least one other learner.

20. The computer-readable media of claim 14, wherein a current learning state is a behavioral state or an emotional state.
